(19) United States
(12) Patent Application Publication
(10) Pub. No.: US 2026/0218884 A1
(43) Pub. Date: Jul. 30, 2026

(54) Folding Paper Wind Lamp

(71) Applicant: QUANZHOU VIITION GIFTS CO., LTD, Quanzhou (CN)

(72) Inventor: Peijun WANG, Jinjiang (CN)

(21) Appl. No.: 19/337,144

(22) Filed: Sep. 23, 2025

(30) Foreign Application Priority Data
Jan. 24, 2025 (CN) 202520166700.1

(51) Int. Cl. F21V 17/00; F21S 9/03; F21V 1/06; F21V 1/18; F21V 23/00

(52) U.S. Cl. CPC F21V 17/007; F21S 9/035; F21V 1/06; F21V 1/18; F21V 23/002

(57) ABSTRACT

The present invention relates to the field of paper wind lamps, and provides a folding paper wind lamp. The folding paper wind lamp includes a folding lampshade, an upper bracket arranged at the top of the folding lampshade, a lower bracket arranged at the bottom of the folding lampshade, and a support frame detachably connected to the upper bracket and the lower bracket. The folding lampshade and the support frame are detachably connected, and the folding lampshade is foldable, so that packaging and transporting costs are reduced, an upper opening has a certain light-transmitting effect, so that an illumination effect of the paper wind lamp is improved, the paper wind lamp is higher in aesthetic property of illumination effect, and a technical problem of high packaging and transporting costs of a solar lamp is solved.

### CROSS-REFERENCE TO RELATED APPLICATIONS

The present application claims priority to Chinese Patent Application No. 202520166700.1, filed January 24, 2025, the entire disclosure of which is incorporated herein by reference.

### TECHNICAL FIELD

The present invention relates to the field of paper wind lamps, and especially relates to a folding paper wind lamp.

### BACKGROUND

An existing solar lamp is usually placed on the ground or suspended on a bracket for illumination, the solar lamp is large in volume, requires a large packaging box for packaging during the packaging, occupies a large space during transporting, and is high in transporting cost, and the solar lamp occupies a large storage space when not in use.

The Chinese patent application number: 201920156162.2 provides a solar outdoor decoration lamp, and the solar outdoor decoration lamp includes a glass cover, a top plate, and a box cover, where the top plate is fixed to the top of the glass cover through bolts and an electricity storage box is installed at the top of the top plate through an installation seat, a micro-inverter is installed at the top of the electricity storage box through an installation frame and a small solar controller is installed at one side of the micro-inverter through an installation seat, a box cover is arranged at the outer side of the top plate in a sleeved manner and a small solar photovoltaic panel is installed at the top of the box cover through an installation groove, an integrated circuit board is fixed to the bottom of the top plate through bolts, and a light-emitting diode is welded to the top of the integrated circuit board and a micro-switch is welded to one side of the light-emitting diode. The solar lamp is large in volume, and high in packaging and transporting costs.

### SUMMARY

Therefore, with regard to the above problems, the present invention discloses a folding paper wind lamp. The technical problem of high packaging and transporting costs of the solar lamp is solved.

In order to realize the above purpose, the present invention adopts the following technical solution:

a folding paper wind lamp includes a folding lampshade, an upper bracket arranged at the top of the folding lampshade, a lower bracket arranged at the bottom of the folding lampshade, and a support frame detachably connected to the upper bracket and the lower bracket, where an upper opening is formed in the top of the folding lampshade, a solar box is arranged on the support frame, and located above the upper opening, a solar assembly is arranged on the solar box, and connected with a lamp source, a side wall or the upper end of the support frame is connected with the upper bracket through a first clamping part, the lower end of the support frame is connected with the lower bracket through a second clamping part, and the upper bracket and the lower bracket are supported through the support frame to enable the folding lampshade to keep an unfolded state.

### Further:

the top of the support frame extends upwards to form a first suspension part.

The two sides of the support frame respectively protrude outwards or recess inwards to form the first clamping part, and the first clamping part can be clamped onto the upper bracket.

The solar box is arranged at the top of the support frame, and a second suspension part is arranged on the solar box.

A light-transmitting pattern is formed on the folding lampshade, and formed by a plurality of light-transmitting holes.

The peripheral side of the opening of the folding lampshade recesses downwards to form an installation groove, the installation groove keeps a downwards-recessing structure through the upper bracket, at least a part of the solar box is located in the installation groove, and the upper opening is located in the lower end of the installation groove.

The upper bracket includes an upper ring, connection rods, and a lower ring which are connected from top to bottom, there are at least two connection rods, the lower ring is arranged at the upper opening, and the upper ring is arranged on the folding lampshade.

The lower part of the support frame is a lower installation part with a V-shaped structure, the second clamping part includes a clamping bar arranged on the lower bracket and a clamping ring arranged at the lower end of the support frame, and the clamping bar can be inserted into the clamping ring.

The upper part of the support frame is an upper installation part with a door-shaped structure, and the first clamping part is formed at a connection position of the upper installation part and the lower installation part.

An installation frame is arranged on the support frame, the lamp source is fixed to the installation frame, and the solar assembly is connected with the lamp source through a lamp wire.

Through adopting the above technical solution, the beneficial effects of the present invention are that:

the folding lampshade and the support frame in the present invention are detachably connected, and the folding lampshade is foldable, so that packaging and transporting spaces are reduced, and packaging and transporting costs are reduced, the solar box is arranged above the upper opening, and the upper opening has a certain light-transmitting effect, so that an illumination effect of the paper wind lamp is improved, and moreover, the whole paper wind lamp is higher in aesthetic property of illumination effect; further, due to the light-transmitting pattern, an outer surface of the paper wind lamp is high in aesthetic property, and moreover, light can pass through the light-transmitting pattern to form an illumination pattern corresponding to the light-transmitting pattern, on the ground or on a wall, so that higher aesthetic property of the illumination effect is achieved; further, the first suspension part is located on the support frame, and installation components can be reduced, so that production and machining costs are reduced; and further, the lamp source is fixed to the installation frame, and enabled to emit light in the folding lampshade, so that a better illumination effect is achieved.

### BRIEF DESCRIPTION OF DRAWINGS

FIG. 1 is a schematic structure diagram of a folding paper wind lamp in an example 1;

FIG. 2 is a sectional view of the example 1;

FIG. 3 is a local exploded diagram of the example 1;

FIG. 4 is a schematic structure diagram of a support frame in the example 1;

FIG. 5 is a sectional view of a folding lampshade in the example 1;

FIG. 6 is a schematic structure diagram that a solar box is abutted against an upper opening, in the example 1;

FIG. 7 is a schematic structure diagram that an installation frame is not arranged;

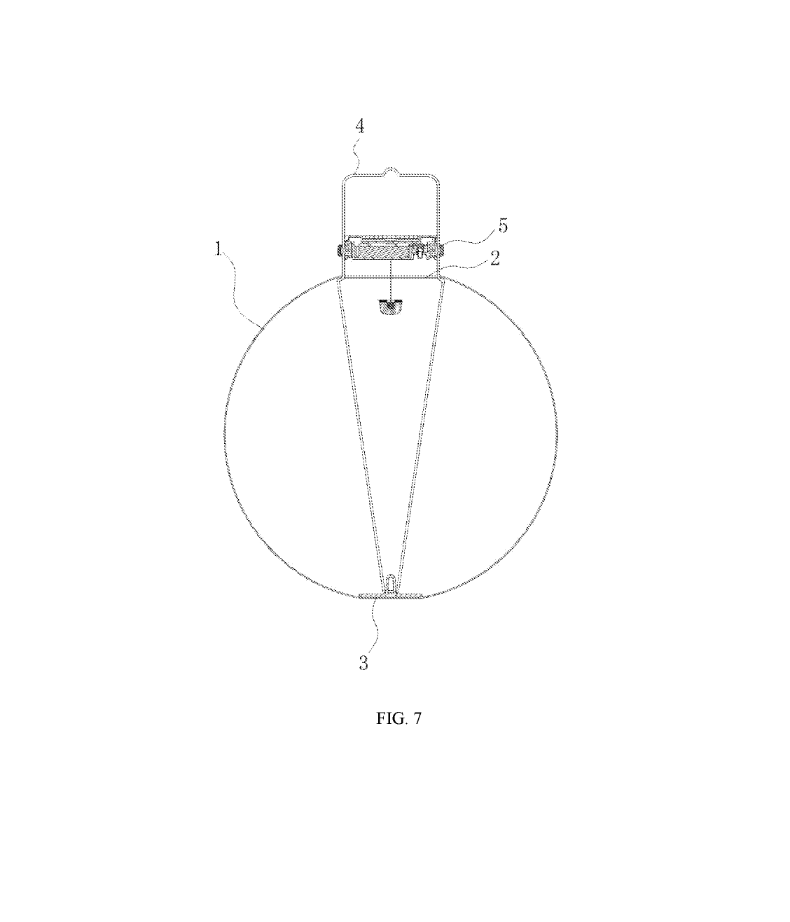

FIG. 8 is a schematic structure diagram of an example 2;

FIG. 9 is a schematic structure diagram of a local structure of an example 2;

FIG. 10 is a schematic structure diagram of an example 3;

FIG. 11 is a sectional view of the example 3;

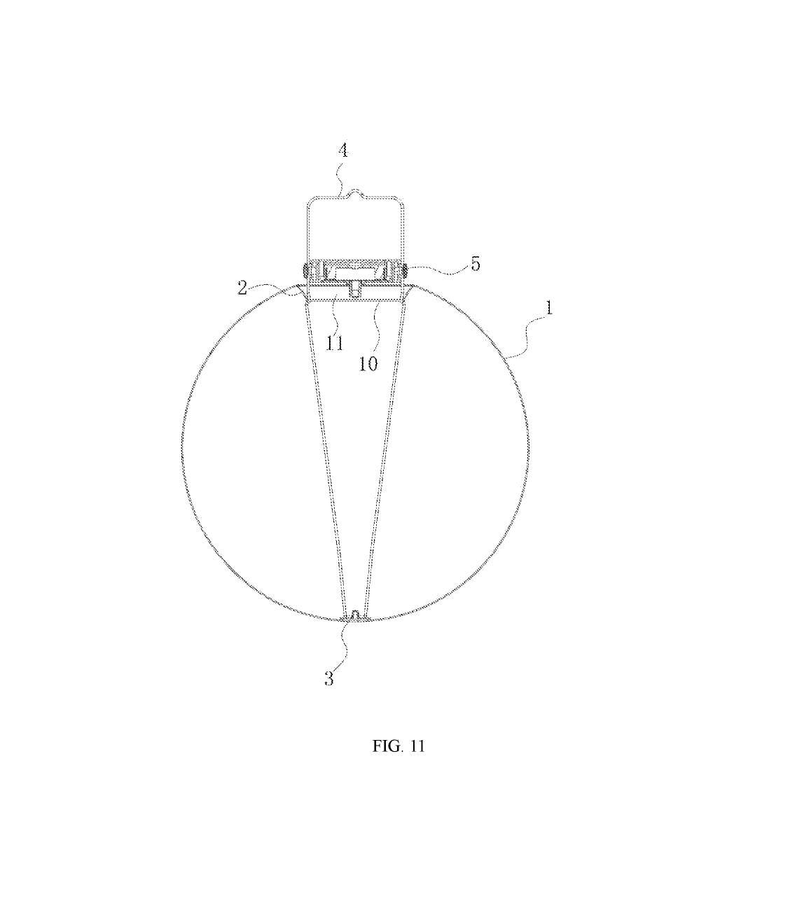

FIG. 12 is a schematic structure diagram of a local structure of the example 3;

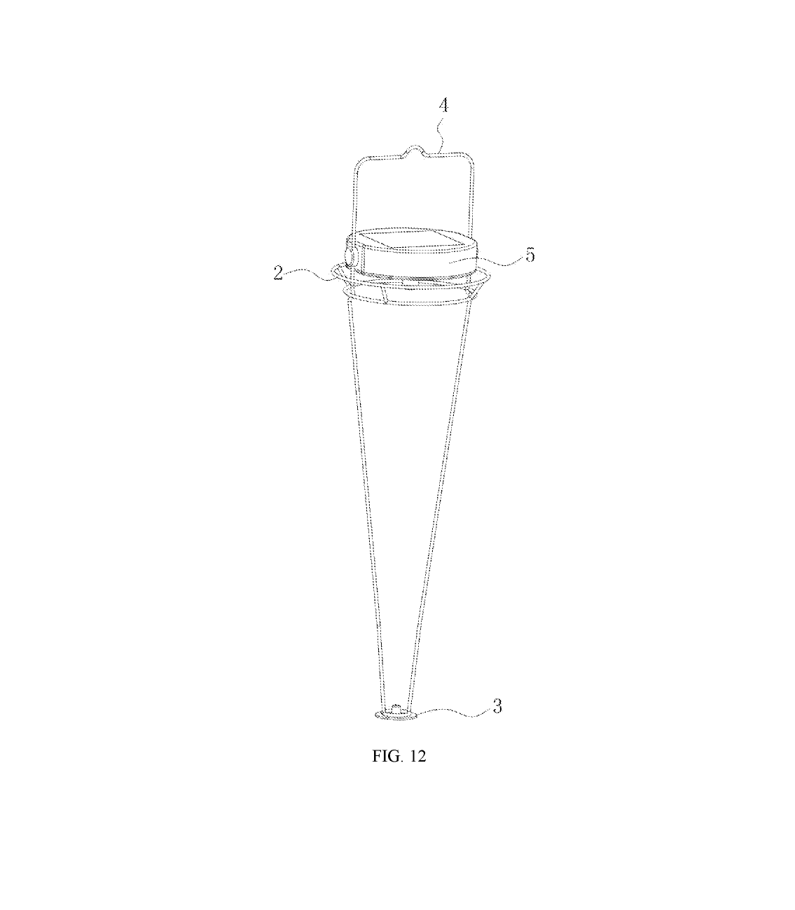

FIG. 13 is a sectional view of a folding lampshade in the example 3; and

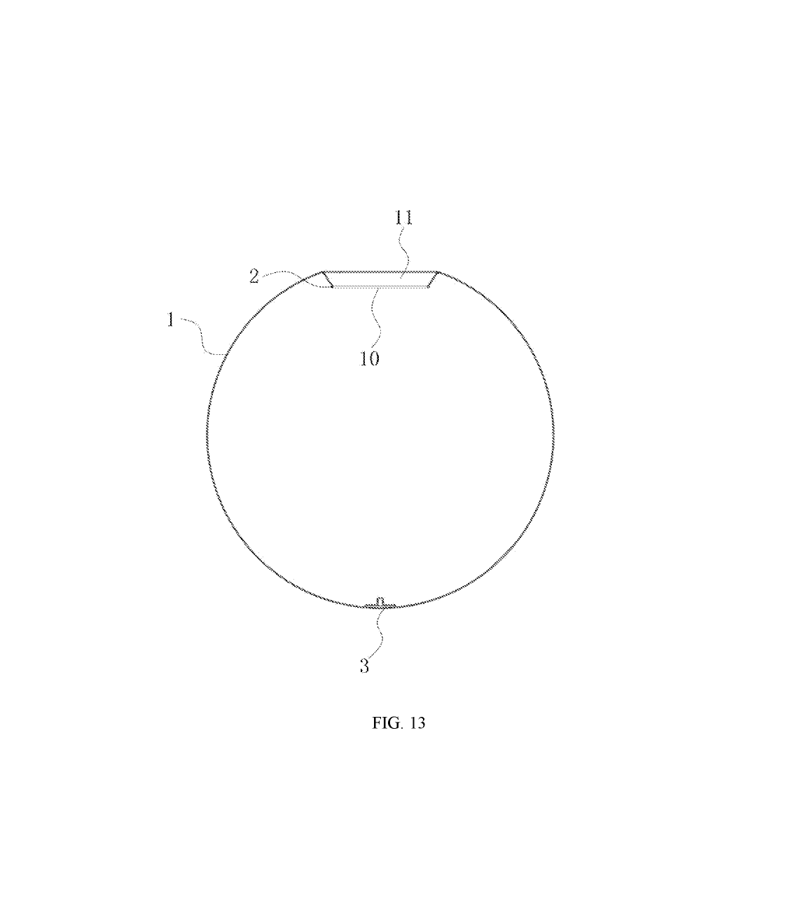

FIG. 14 is a schematic structure diagram of an upper bracket in the example 3.

### Marks of the Drawings:

1. folding lampshade; 10. upper opening; 11. installation groove; 2. upper bracket; 21. upper ring; 22. connection rod; 23. lower ring; 3. lower bracket; 30. clamping bar; 4. support frame; 41. first clamping part; 42. second clamping part; 420, clamping ring; 43. upper installation part; 44. lower installation part; 45. first suspension part; 46. installation frame; 5. solar box; 6. solar assembly; 7. lamp source; 70. lamp wire; and 8. second suspension part.

### DETAILED DESCRIPTION OF THE EMBODIMENTS

The present invention is further described in conjunction with the drawings and specific implementation manners.

### Example 1:

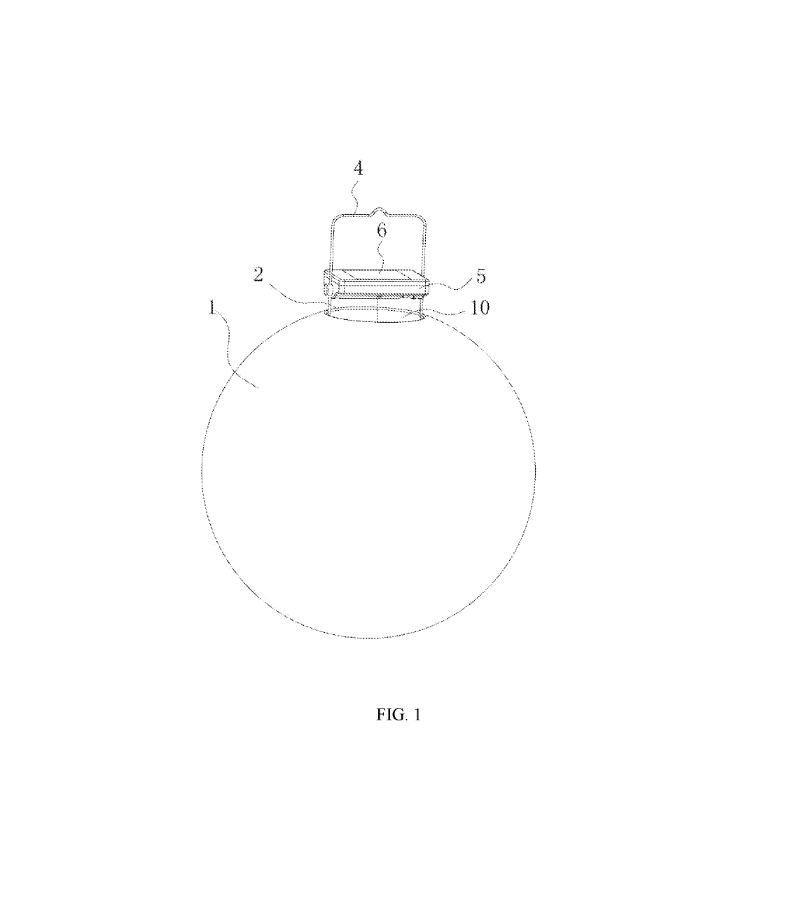

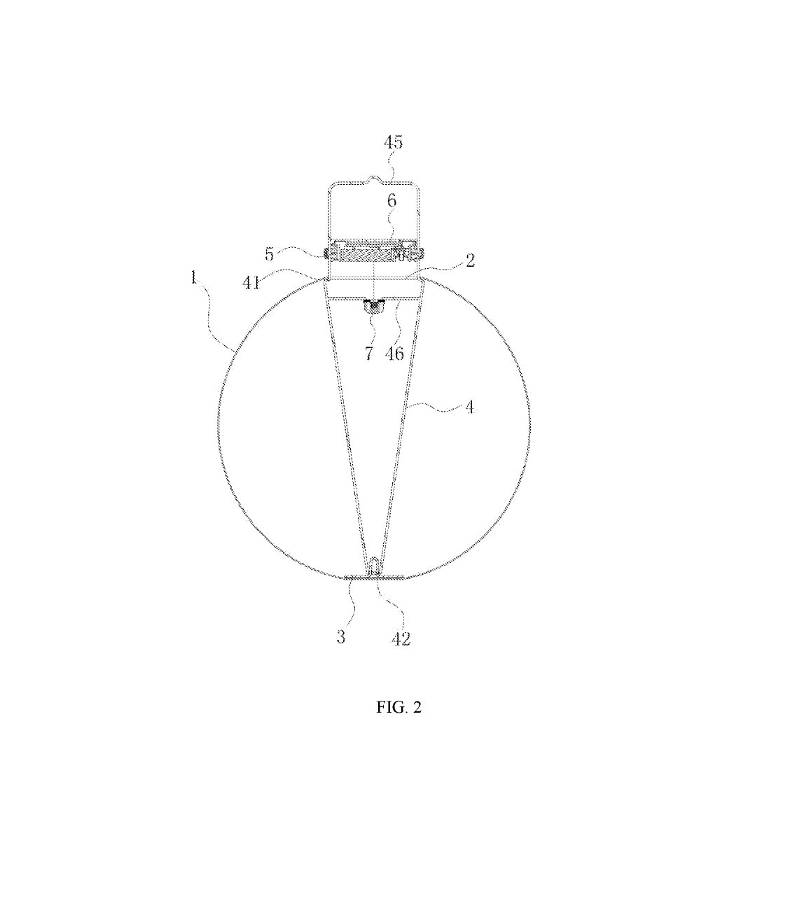

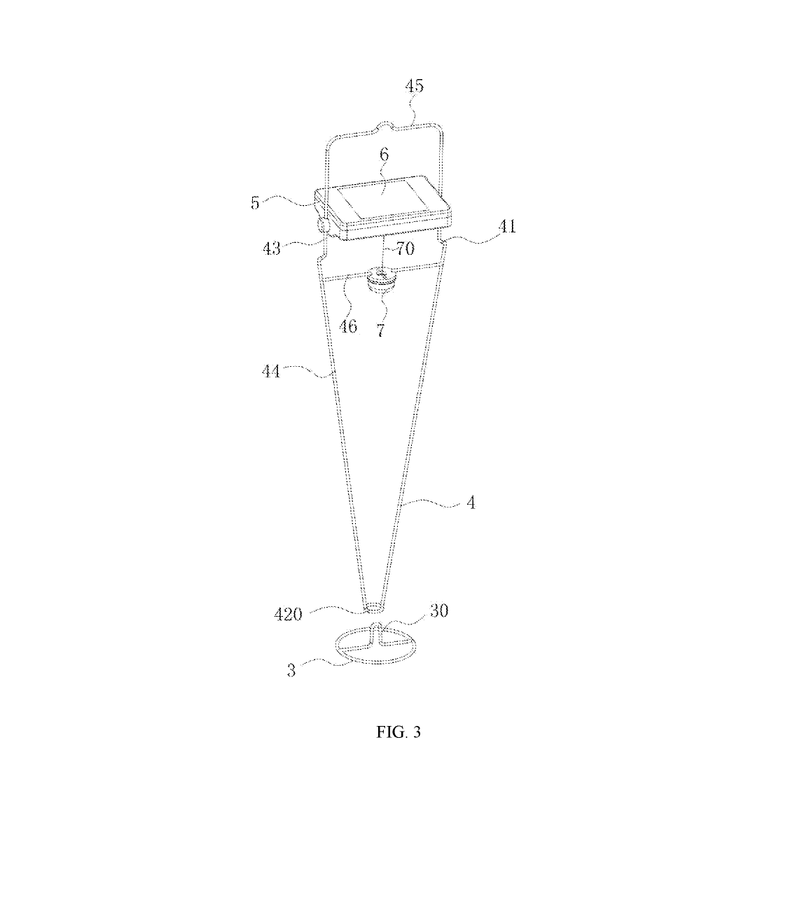

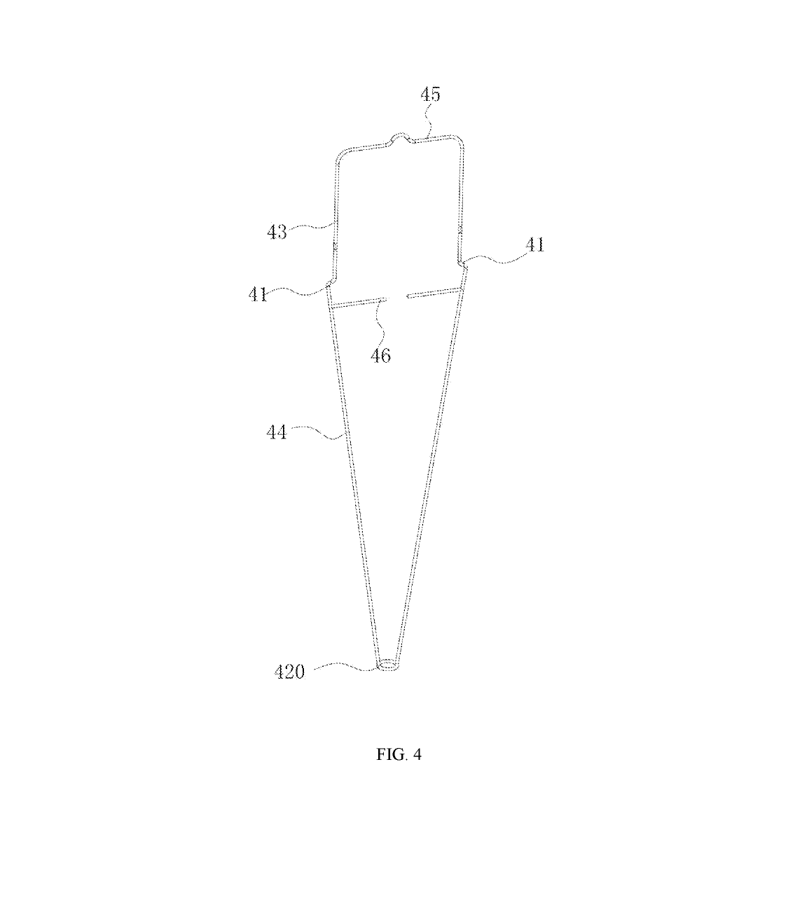

Referring to FIG. 1 to FIG. 5, the example 1 provides a folding paper wind lamp, and the folding paper wind lamp includes a folding lampshade 1, an upper bracket 2 arranged at the top of the folding lampshade 1, a lower bracket 3 arranged at the bottom of the folding lampshade 1, and a support frame 4 detachably connected to the upper bracket 2 and the lower bracket 3, where an upper opening 10 is formed in the top of the folding lampshade 1, a solar box 5 is arranged on the support frame 4, and located above the upper opening 10, a solar assembly 6 is arranged on the solar box 5, and connected with a lamp source 7, the two sides of the support frame 4 respectively recess inwards to form the first clamping part 41, and the first clamping part 41 can be clamped onto the upper bracket 2. The lower end of the support frame 4 is connected with the lower bracket 3 through a second clamping part 42, the support frame 4 includes an upper installation part 43 and a lower installation part 44 which are arranged in an up-down direction, the first clamping part 41 is formed at a connection position of the upper installation part 43 and the lower installation part 44, the upper installation part 43 is of a door-shaped structure, the lower installation part 44 is of a V-shaped structure, the second clamping part 42 includes a clamping bar 30 arranged on the lower bracket 3 and a clamping ring 420 arranged at the lower end of the support frame 4, and the clamping bar 30 can be inserted into the clamping ring 420. The upper bracket 2 and the lower bracket 3 are supported through the support frame 4 to enable the folding lampshade 1 to keep an unfolded state. The top of the support frame 4 extends upwards to form a first suspension part 45. An installation frame 46 is arranged on the support frame 4, the lamp source 7 is fixed to the installation frame 46, and the solar assembly 6 is connected with the lamp source 7 through a lamp wire 70.

In one example, the first clamping part 41 may also be formed through outwards-protruding of the support frame 4, and in another example, a clamping buckle, a clamping piece or other components that can be clamped onto the upper bracket 2 may be arranged on the support frame 4.

In one example, the second clamping part 42 is an insertion groove formed in the lower bracket 3, and the lower end of the support frame 4 is inserted into the insertion groove to be fixed; and in another example, the second clamping part 42 may also be arranged to be of a structure for connecting the lower bracket 3 with the support frame 4 through a thread, and may also be a clamping buckle or be of other structures.

A lower opening is not formed in the bottom of the folding lampshade 1 in the example; and in another example, a lower opening may also be formed in the bottom of the folding lampshade 1, the bottom of the folding lampshade 1 has a better light-transmitting effect, and is also convenient for installation and fixing for the lower bracket 3, and during unfolding, the unfolding may be carried out through pulling the upper opening 10 and the lower opening, so that the folding lampshade 1 is more convenient to unfold.

The above upper bracket 2 is usually arranged to be of a circular structure, and may also be arranged to be of a rectangular structure, a triangular structure, a hexagonal structure, or other structures.

The bottom of the support frame 4 in the example is of a V-shaped structure, and the lower end has a small area, so that the whole folding lampshade 1 is of a spherical structure; and in another example, the above support frame 4 may also be arranged to be of a rectangular structure, an elliptical structure, or structures with other shapes.

Stainless steel, iron, aluminum or other materials may be adopted for the above support frame 4, and the above support frame 4 may usually be deformed to a certain extent through pressing, so that detachment and installation between the support frame 4 and the upper bracket 2 are realized.

The two ends of the above solar box 5 are fixed to the support frame 4; in one example, the solar box 5 and the support frame 4 may be arranged to be detachably connected; in one example, the solar box 5 may also be arranged to be rotatably connected to the support frame 4; and in another example, the solar box 5 is also arranged to be fixed to the support frame 4 in a position-adjustable manner.

The above solar assembly 6 is a well-known component, and in one example, the solar assembly 6 includes a solar panel, an inverter, a storage battery, and a switch; in one example, the solar assembly 6 may further include a photoresistor, a time relay, or other components; in one example, the above solar assembly 6 may further include a control chip; and in one example, the above solar assembly 6 may be a general term for integrated solar cells, and may include components with many functions.

The above lamp source 7 may be an LED lamp, or may be a lamp assembly, and includes a lamp holder, a lampshade, or other lamp-related components.

The above folding lampshade 1 is usually made of transparent materials such as paper and cloth, or other foldable materials; and the above folding lampshade 1 is of a well-known structure and made of a well-known material, which will not be further elaborated herein. In one example, a light-transmitting pattern is formed on the above folding lampshade 1, and formed by a plurality of light-transmitting holes, and the light-transmitting pattern may be formed to be flowers, stars, moon, animals, and other patterns, and light can pass through the light-transmitting pattern to form an illumination pattern corresponding to the light-transmitting pattern, on the ground or on a wall, so that higher aesthetic property of the illumination effect is achieved; and in another example, a light-transmitting pattern may also be not formed on the folding lampshade 1, and the structure is simple in illumination effect.

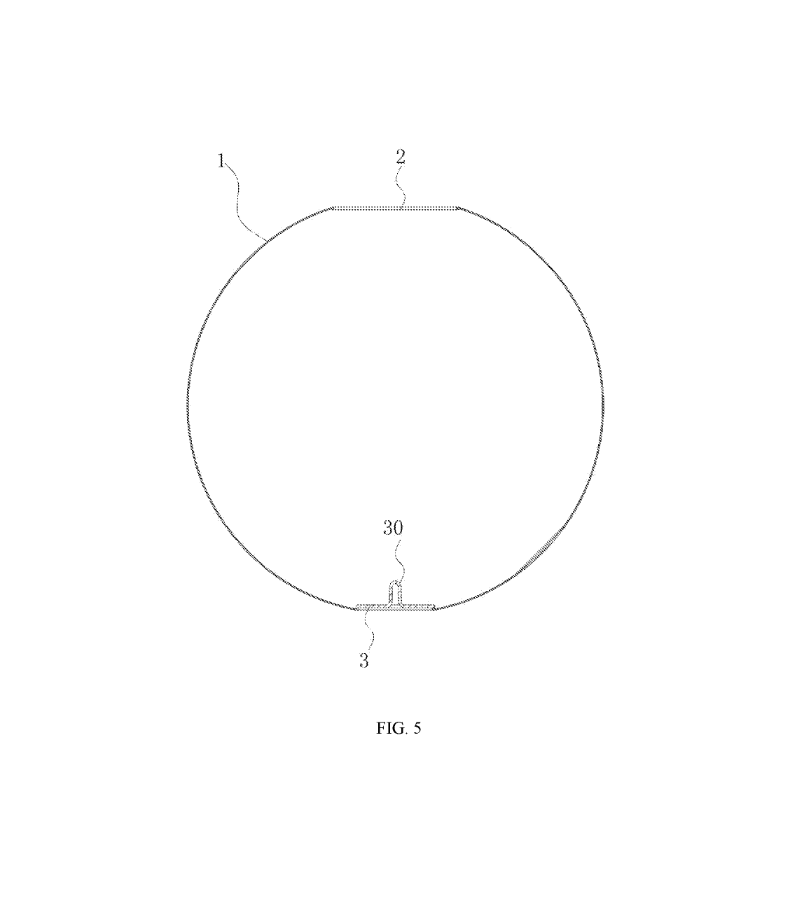

A distance between the solar box 5 and the upper opening 10 in the example is usually not less than 3 centimeters, the distance between the solar box 5 and the upper opening 10 may be 3 centimeters, 4 centimeters, 5 centimeters, or even more, and it may be visually seen that the solar box 5 and the upper opening 10 are of a separated structure; in one example, the distance between the solar box 5 and the upper opening 10 may also be less than 3 centimeters, and in the structure, the distance between the solar box 5 and the upper opening 10 is small; and in another example, as shown in FIG. 5, the solar box 5 may also be abutted against the upper opening 10.

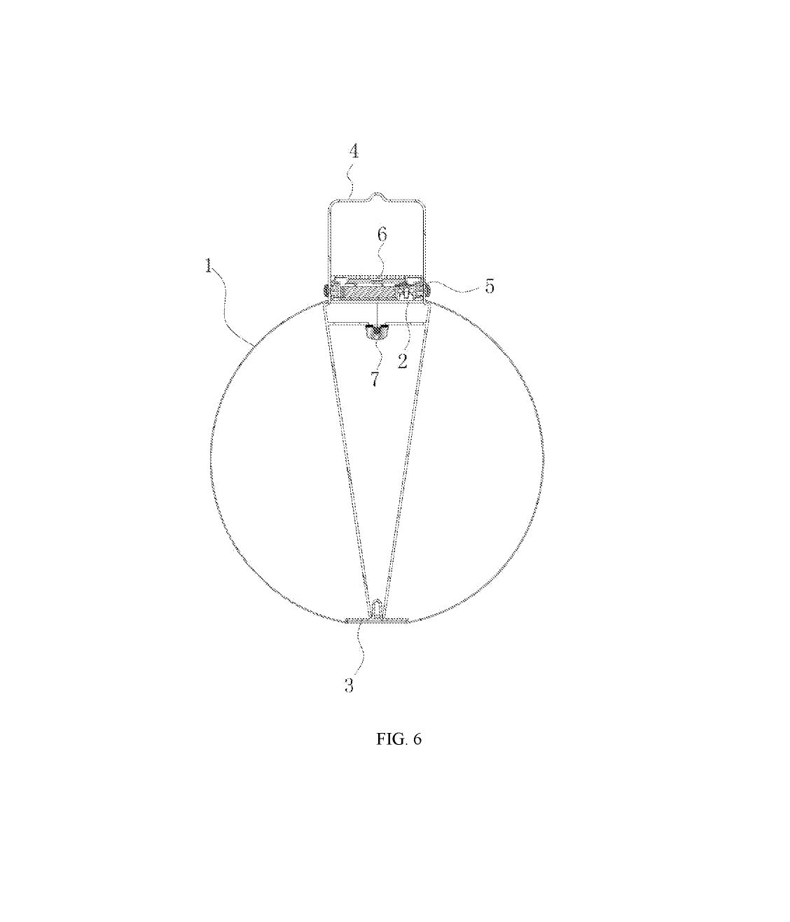

In one example, as shown in FIG. 6, the above installation frame 46 may also be not arranged, and the lamp source 7 is connected and suspended in the lampshade through the lamp wire 70; in one example, the above lamp source 7 may also be installed at the bottom of the solar box 5, and irradiates downwards into the folding lampshade 1, and the structure is poor in irradiation effect; and in another example, the installation frame 46 may be arranged at the bottom of the solar box 5.

### A working manner of the example 1 is that:

during installation for the paper wind lamp, the paper wind lamp is unfolded, the support frame 4 extends into the folding lampshade 1 from the upper opening 10, the clamping ring 420 at the bottom of the support frame 4 is arranged on the clamping bar 30 in a sleeved manner, the upper opening 10 of the paper wind lamp is pulled, and meanwhile, the two ends of the support frame 4 are pressed, the support frame 4 is deformed until the paper wind lamp is unfolded to the maximum state, the first clamping part 41 is clamped onto the upper bracket 2, and the upper bracket 2 and the lower bracket 3 are supported through the support frame 4 to enable the folding lampshade 1 to keep an unfolded state, when the lamp source 7 is turned on, a part of light can irradiate from the upper opening 10, and can pass through the light-transmitting holes of the light-transmitting pattern to form an illumination pattern corresponding to the light-transmitting pattern, on the ground or on a wall, so that higher aesthetic property of the illumination effect is achieved; and during detachment for the paper wind lamp, the two ends of the support frame 4 are pressed, and meanwhile, the upper opening 10 of the paper wind lamp is pulled to enable the first clamping part 41 to be separated from the upper bracket 2, and the support frame 4 is taken out, and due to the structure, the paper wind lamp is convenient and rapid to detach and install, so that packaging and transporting are facilitated.

### Example 2:

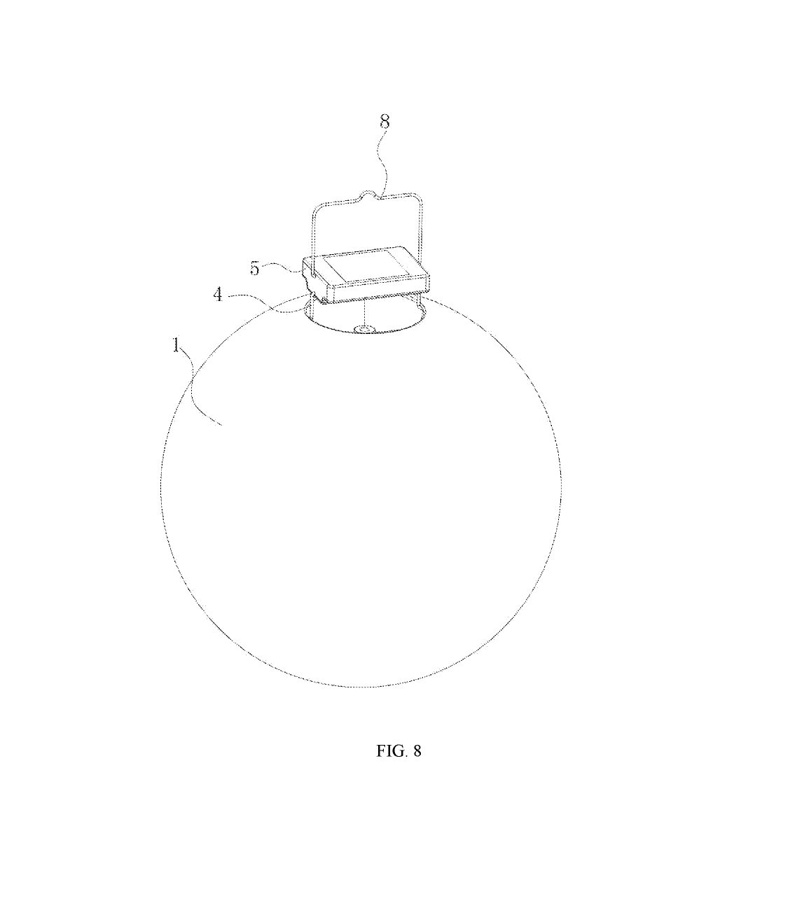

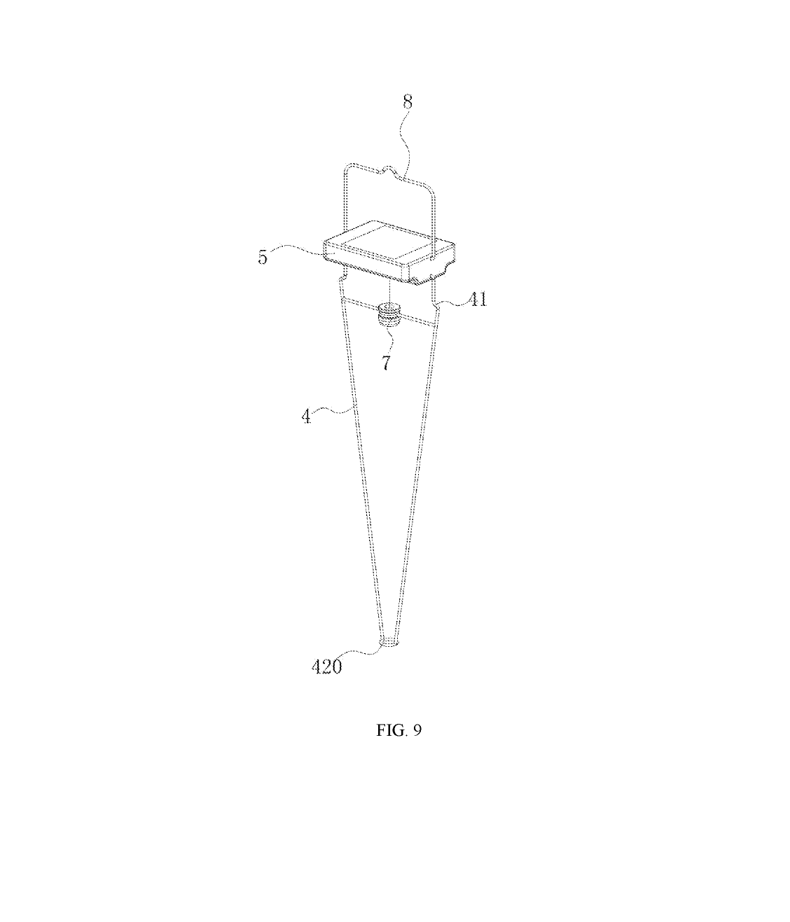

Referring to FIG. 8 and FIG. 9, a main difference between the example 2 and the example 1 is that: the solar box 5 in the example 2 is arranged at the top of the support frame 4, and the second suspension part 8 is arranged on the solar box 5.

### Example 3:

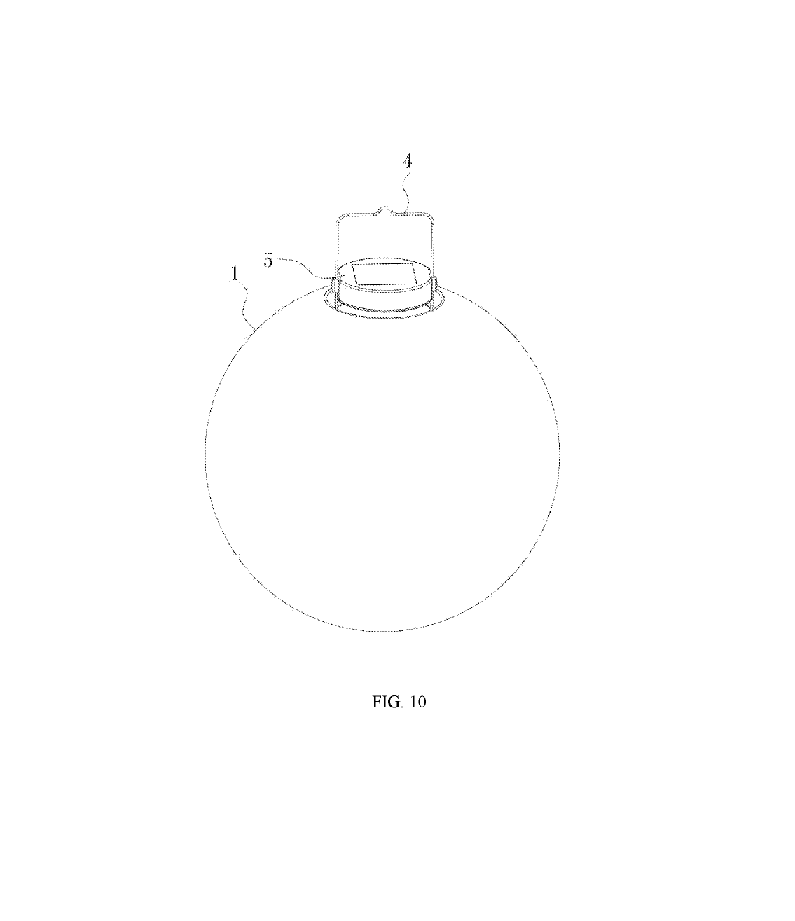

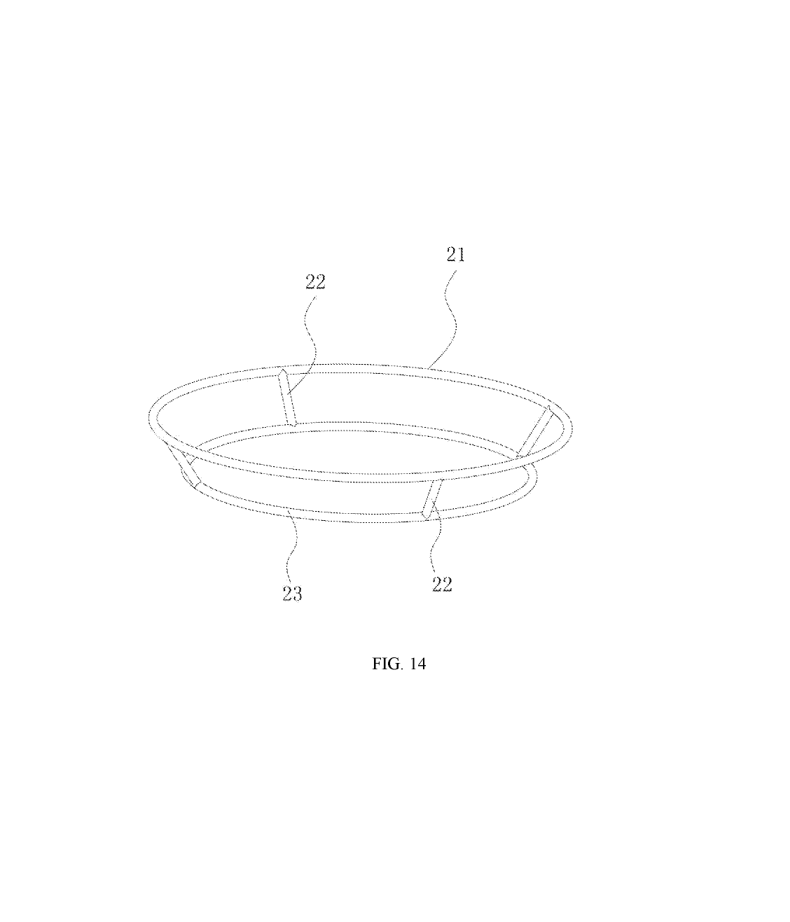

Referring to FIG. 10 and FIG. 14, a main difference between the example 3 and the example 1 is that: the peripheral side of the opening of the folding lampshade 1 in the example 3 recesses downwards to form an installation groove 11, the installation groove 11 keeps a downwards-recessing structure through the upper bracket 2, at least a part of the solar box 5 is located in the installation groove 11, and the upper opening 10 is located in the lower end of the installation groove 11. The upper bracket 2 includes an upper ring 21, connection rods 22, and a lower ring 23 which are connected from top to bottom, there are at least two connection rods 22, the lower ring 23 is arranged at the upper opening 10, the upper ring 21 is arranged on the folding lampshade 1, and the lamp source 7 is arranged at the bottom of the solar box 5.

When the paper wind lamp in the example 3 is unfolded, the solar box 5 and the folding lampshade 1 are usually arranged to be of a non-contact structure, and a part of a lamp tube may irradiate out from the upper opening 10. In one example, the solar box 5 may also be in local contact with the folding lampshade 1; and in another embodiment, the bottom of the solar box 5 may also be completely abutted against and shield the upper opening 10.

The solar box 5 in the example 3 can be locally hidden in the installation groove 11, and from an external perspective, the solar box 5 is small in thickness, and the solar box 5 and the whole folding lampshade 1 look like a whole in appearance, so that higher compactness and aesthetic property of the structure are achieved.

Although the present invention is specifically demonstrated and introduced in combination with the preferred implementation solutions, those skilled in the art should understand that, various variations may be made on the present invention in form and detail without deviating from the spirit and the scope of the present invention limited by the appended claims, all fall within the protection scope of the present invention.

What is claimed is:

1. A folding paper wind lamp, comprising a folding lampshade, an upper bracket arranged at the top of the folding lampshade, a lower bracket arranged at the bottom of the folding lampshade, and a support frame detachably connected to the upper bracket and the lower bracket, wherein an upper opening is formed in the top of the folding lampshade, a solar box is arranged on the support frame, and located above the upper opening, a solar assembly is arranged on the solar box, and connected with a lamp source, a side wall or the upper end of the support frame is connected with the upper bracket through a first clamping part, the lower end of the support frame is connected with the lower bracket through a second clamping part, and the upper bracket and the lower bracket are supported through the support frame to enable the folding lampshade to keep an unfolded state.

2. The folding paper wind lamp according to claim 1, wherein the top of the support frame extends upwards to form a first suspension part.

3. The folding paper wind lamp according to claim 1, wherein the two sides of the support frame respectively protrude outwards or recess inwards to form the first clamping part, and the first clamping part can be clamped onto the upper bracket.

4. The folding paper wind lamp according to claim 1, wherein the solar box is arranged at the top of the support frame, and a second suspension part is arranged on the solar box.

5. The folding paper wind lamp according to claim 1, wherein a light-transmitting pattern is formed on the folding lampshade, and formed by a plurality of light-transmitting holes.

6. The folding paper wind lamp according to claim 1, wherein the peripheral side of the opening of the folding lampshade recesses downwards to form an installation groove, the installation groove keeps a downwards-recessing structure through the upper bracket, at least a part of the solar box is located in the installation groove, and the upper opening is located in the lower end of the installation groove.

7. The folding paper wind lamp according to claim 6, wherein the upper bracket comprises an upper ring, connection rods, and a lower ring which are connected from top to bottom, there are at least two connection rods, the lower ring is arranged at the upper opening, and the upper ring is arranged on the folding lampshade.

8. The folding paper wind lamp according to claim 1, wherein the lower part of the support frame is a lower installation part with a V-shaped structure, the second clamping part comprises a clamping bar arranged on the lower bracket and a clamping ring arranged at the lower end of the support frame, and the clamping bar can be inserted into the clamping ring.

9. The folding paper wind lamp according to claim 8, wherein the upper part of the support frame is an upper installation part with a door-shaped structure, and the first clamping part is formed at a connection position of the upper installation part and the lower installation part.

10. The folding paper wind lamp according to claim 1, wherein an installation frame is arranged on the support frame, the lamp source is fixed to the installation frame, and the solar assembly is connected with the lamp source through a lamp wire.
